(19) United States
(12) Patent Application Publication
(10) Pub. No.: US 2002/0049614 A1
(43) Pub. Date: Apr. 25, 2002

(54) Image signatures with unique watermark ID

(76) Inventors: Marion R. Rice, Rochelle, TX (US); Bindu R. Rao, Austin, TX (US)

Correspondence Address: CHRISTOPHER C. WINSLADE, 2135 N. CLIFTON AVENUE, CHICAGO, IL, 60614, US

(21) Appl. No.: 09/823,898

(22) Filed: Mar. 30, 2001

Related U.S. Application Data
(60) Provisional application No. 60/206,851, filed on May 23, 2000.

(51) Int. Cl. G06F 17/60

(52) U.S. Cl. 705/3

(57) ABSTRACT

A healthcare network that is used by doctors, patients, nurses, home healthcare agencies, hospitals, etc. employs digital signatures for providing secure access to documents and other information. It also employs watermarked electronic image signatures to authenticate the documents and other information. When a user, such as a doctor, signs a document, such as a patient's documents, a watermarked electronic image signature of the user is selectively employed, along with the user's digital signatures that are based on public and private keys, to authenticate the user and determine the identity of the signer. Such a mechanism makes it possible to employ the watermarked electronic image signature as proof of the user having signed the document. In addition, when the document is printed or viewed on the screen, the inclusion of the electronic image signature on the display or the insertion of the watermarked electronic image signature in the printed output helps confirm the fact that the document has been previously signed, while also providing information about the signer's identity.

### CROSS-REFERENCE TO RELATED APPLICATIONS

This application makes reference to, and claims priority to and the benefit of, U.S. provisional application Serial No. 60/206,851 filed May 23, 2000.

### STATEMENT REGARDING FEDERALLY SPONSORED RESEARCH

NA

### INCORPORATION BY REFERENCE

U.S. provisional application Serial No. 60/206,851 filed May 23, 2000 is hereby incorporated by reference herein in its entirety.

### BACKGROUND OF THE INVENTION

1. Technical Field

The present invention relates generally to the signing of documents in a healthcare environment, and more specifically to the application of electronic image signatures and other authentication related techniques to the process of accessing documents.

2. Related Art

The home healthcare industry is undergoing computerization although, for the most part, much of the referral, assessment, form generation, and form processing take place manually. When doctors or healthcare providers access patient and patient care information, such access needs to be secure and only authorized personnel must be allowed access to sensitive information such as patient information. In addition, documents pertaining to care and services provided by nurses and other care providers are typically signed by a doctor as part of an “approval” or “oversight” process. The doctor's signature is essential for processing care related information in hospitals and home healthcare agencies, and are often required before disbursement of funds in order to compensate the parties involved.

### SUMMARY OF THE INVENTION

Aspects of the present invention may be found in a healthcare network having a document database that stores one or more patient documents. A patient document has a digital signature of a signor, such as, for example, that of a doctor. The digital signature may be, for example, an electronic image signature. The healthcare network further has a web server that is communicatively coupled to the document database and to a computer. The computer may be that of a doctor, nurse or patient, for example. The computer runs browser software that is used by the operator of the computer to review the patient document. The web server delivers to the computer one or more web pages that display the patient document and at least an indication of the digital signature. If the digital signature is not present, the indication of the digital signature may be used to obtain the digital signature from a signature database. In either case, the computer, responsive to user input via the one or more web pages, at least causes a watermark ID to be generated using at least information regarding the signor of the patient document.

In one embodiment the watermark ID is generated also using information regarding the patient document and/or information regarding the patient. In any case, the healthcare network may selectively verify the authenticity of the patient document using the watermark ID and/or the digital signature. In addition, the computer may, in response to user input via the one or more web pages, cause the watermark ID and the digital signature to be merged. The computer may display the watermark ID, with or without the digital signature, for review and verification by the user.

In one embodiment, the watermark ID is a barcode that, for example, authenticates the signor and verifies that the document and digital signature belong together. The watermark ID may then be associated with the patient document, and both may be stored in the document database.

Other aspects, advantages and novel features of the present invention will become apparent from the following detailed description of the invention when considered in conjunction with the accompanying drawings.

### BRIEF DESCRIPTION OF THE DIAGRAMS

The numerous objects and advantages of the present invention may be better understood by those skilled in the art by reference to the accompanying figures in which:

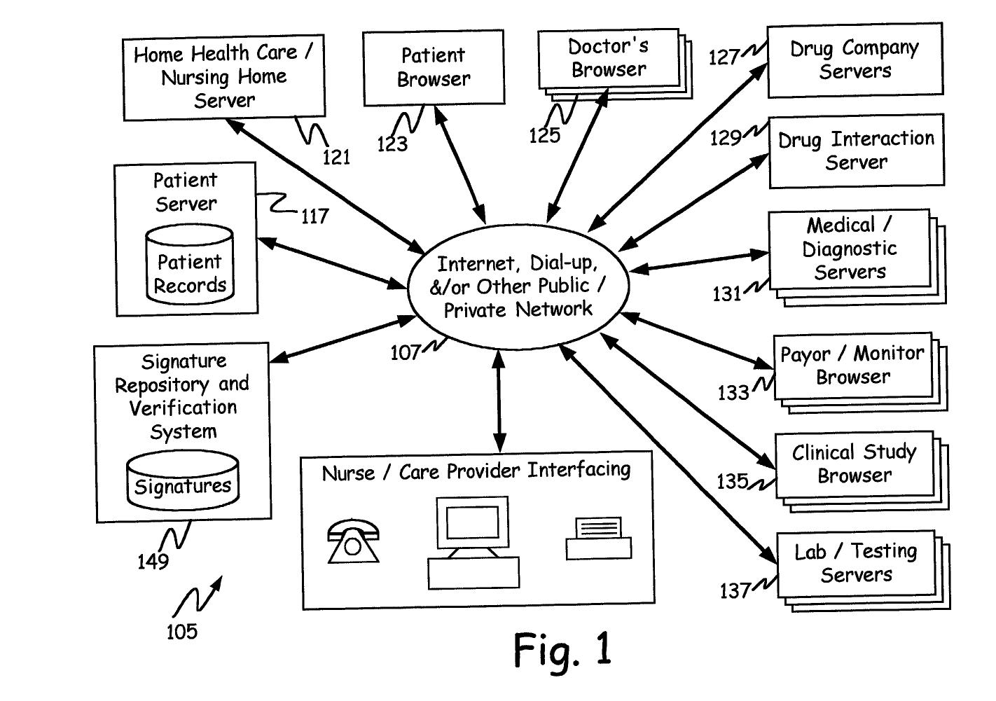

FIG. 1 is a perspective diagram of a healthcare network that facilitates retrieval of various patient, drugs and medical care related information from a plurality of sources, while also providing an authentication and security mechanism that is based on electronic image signatures with customizable watermarks as well as on digital signatures;

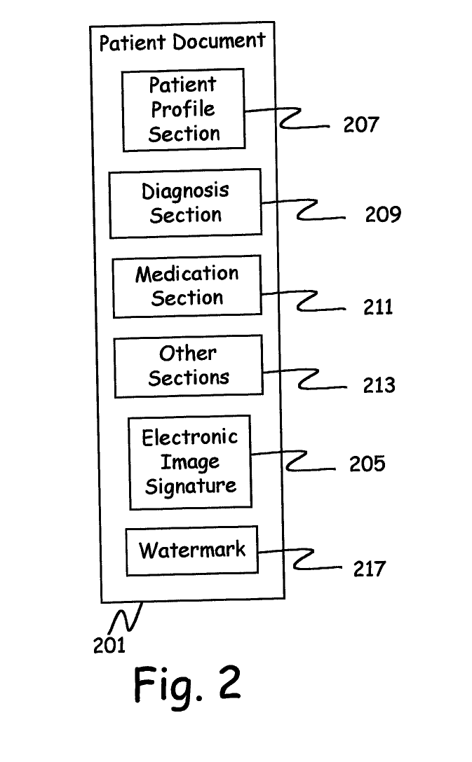

FIG. 2 is a perspective block diagram of an exemplary patient's document into which is embedded an electronic image signature of the doctor along with a unique watermark ID, when the doctor signs the document; and

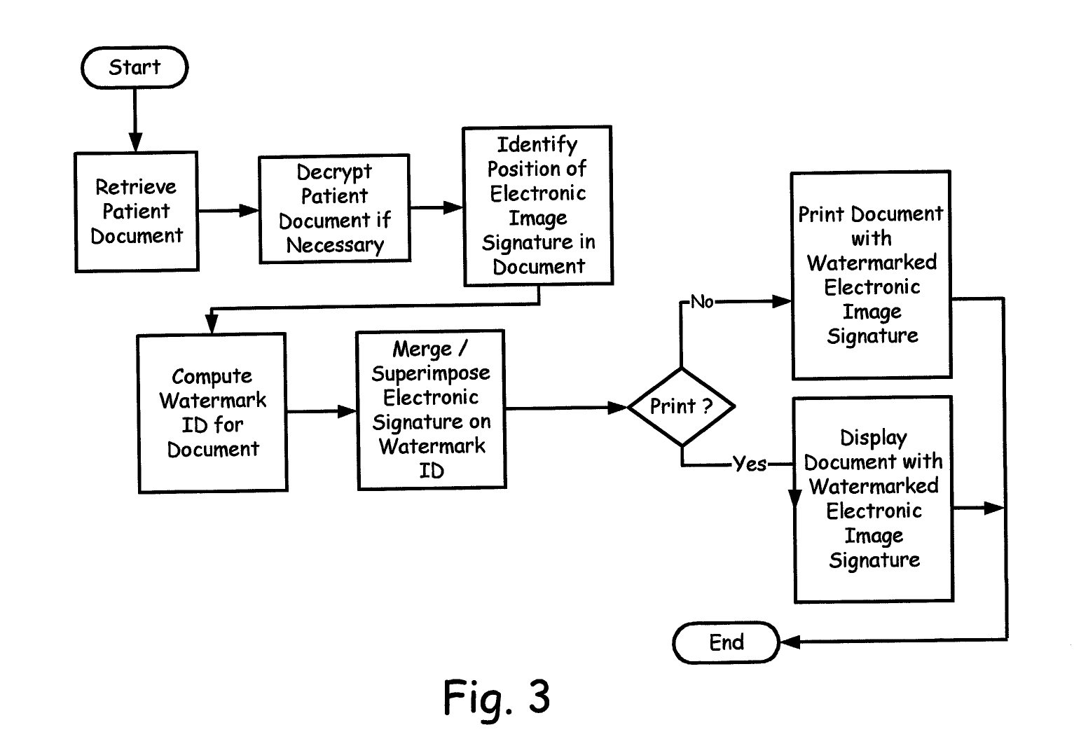

FIG. 3 is a block diagram showing the details of a print and a display operation for a patient document that has an associated electronic image signature with watermark ID.

### DETAILED DESCRIPTION OF THE INVENTION

FIG. 1 is a perspective diagram of a healthcare network 105 that facilitates retrieval of various patient, drugs and medical care related information from a plurality of sources, while also providing an authentication and security mechanism that is based on electronic image signatures with customizable watermarks as well as on digital signatures. The retrieval of various patient, medical drugs, and medical care related information, etc. from a plurality of sources by a plurality of users (using web browsers), such as a doctor, a patient, a nurse at a payer office, or a nurse at a clinical study office using a doctor's browser 125, a patient browser 123, a payer monitor browser 133 or a clinical study browser 135, respectively, is controlled by associated servers and/or systems. Such control on information access is implemented by selectively employing the dual and complementary security mechanisms provided by the healthcare network 105.

More than one consumer of various records provided for viewing or for printing by healthcare network 105 may view the records and ascertain if the records have been signed. Signed records typically display the signatures of the person who signed the document. For example, electronic patient records signed by a doctor typically incorporate the electronic image signature of the doctor. Such electronic image signatures are displayed or printed in the healthcare network 105 after incorporating a watermark ID into the displayed or printed electronic image signature.

In one embodiment, the watermark ID is typically a unique identification of the document that is generated based upon a formula that selectively incorporates information identifying the associated document, information associated with the individual signing the document, information associated with the subject of the document such as the patient whose record a document incorporates, etc. The watermark ID is displayed as a watermark for the electronic image signature, and the position of the watermark ID is customizable. A user viewing a printed version of the document or viewing a document on a computer screen would not only be able to clearly view the signature but also read the watermark ID so that the user may subsequently choose to verify the authenticity of the electronic image signature, if necessary, by using the watermark ID. For example, a user, with a copy of a printed version of a signed document may retrieve an electronic copy of the document along information about the signer of the document using the watermark ID as a reference, and also retrieve an original signature of the signer of the document for comparison (either electronic or visual) with the signature on the signed document. In addition, the user can verify if the document and the signature belong together by retrieving the document (and its associated electronic image signature) based upon the watermark ID on a printed version of the document (or an onscreen visible version) and comparing the electronic image signatures of the one that is visible with the one on the document retrieved.

In another embodiment, the watermark ID incorporated into an electronic image signature after a user signs the associated document takes the form of a bar code that is merged with the electronic image signature when the document is displayed or printed subsequently. The barcode can subsequently be used to retrieve the signed document and/or information about the signer of the document (i.e. the user).

In yet another embodiment, the electronic image signature is modified, for display on a screen or for printing, based upon a pattern, the pattern generated using a formula that incorporates various inputs such as the information identifying the associated document, information associated with the individual signing the document, information associated with the subject of the document such as the patient whose record a document incorporates, etc. The pattern, when applied to the electronic image signature, causes portions of the electronic image signature to change in tone, in color, or in some other non-obvious characteristics such that the electronic image signature is still visible to the naked eye when the document is printed or viewed on the screen. The pattern is typically computed on the fly and applied to the electronic image signature before the signature is displayed or printed. The pattern is also selectively stored with the signed document for subsequent processing, archival or retrieval. In one embodiment, the pattern may be extracted from a printed document or from a screen shot of a visible electronic image signature and compared to the computed or retrieved pattern to verify its authenticity.

Using their browsers 123 and 125, patients and doctors, respectively, selectively review patient records from a plurality of sources of patient information, medical drugs and medical care related information from a home healthcare/nursing home server 121, drug related information from drug company servers 127, a drug interaction information from a drug interaction server 129, diagnostic and other medical information from medical/diagnostic servers 131, test results and related information from lab/testing servers 137, and patient records and patient history records from a patient server 117. In one embodiment, all of these patient related information is retrieved after authenticating the consumer, where the information required to authenticate the consumer, such as the consumer's public and private keys, passwords, electronic signatures, etc. are all selectively stored at, and selectively accessed from, the signature repository and verification system 149. Again, communication between the various producers and consumers of various patient, medical drugs and medical care related information is facilitated by Internet, Dial-up, &/or other public/Private Network 107.

In one embodiment of the present invention, the healthcare network 105 is a home healthcare network that provides support for processing patient and patient care, diagnostics and medication related information to patients, doctors, home healthcare agencies, etc., where each patient's documents are selectively signed, either using digital signatures or employing electronic image signatures with watermark IDs, by doctor's and/or nurses as part of the patient care oversight process. In another embodiment, the healthcare network 105 is a hospital care network where a plurality of participating hospitals and nursing home servers provide access to patient and patient care related information to a plurality of patients, doctors, nurses etc. In yet another embodiment of the present invention, the healthcare network 105 allows a plurality of hospital servers, nursing home servers, home healthcare servers, medical diagnostic servers, drug company servers, etc. to participate in providing access to patient, patient care, diagnostics and medication related information to doctors, nurses, patients, etc.

In general, various kinds of information is provided by the healthcare network 105 to a plurality of consumers, such as a doctor who uses the doctor's browser 125, a payer using a payer/monitor browser 133, a clinical study browser 135 or a patient using a patient's browser 123. Each of the consumers of information in the healthcare network 105 is selectively subjected to security checks before access to information is granted by the healthcare network 105. In addition to security checks, the authenticity of information and the identity of the creator and/or sender of information are verified using digital signature techniques based on public keys, private keys, digital signatures and certificates. Typically, verification of the consumer's right to access the requested information is automatically performed by associated systems or software without any human intervention, such as security implemented by a secure socket layer employed for communications between systems. However, when patient documents and patient-related information is printed or viewed on a screen, in order to promote visual and human readable authentication of the creator or sender of information, an electronic image signature is also incorporated into, or associated with, such information. Such electronic image signature may be treated as part of the newly created or sent information and subjected to processing during the creation and verification of the digital signature of the associated creator or sender. Again, when signed documents containing electronic image signatures are displayed or viewed, a watermark ID is incorporated into the electronic image signatures.

In one embodiment, when information is created or reviewed in the healthcare network 105, such information is selectively signed by a creator or reviewer of information, such as a doctor reviewing patient records or a home healthcare agency reviewing care plan oversight records, and the signed information may subsequently be accessed by other consumers. The process of signing a document by a viewer, such as by a doctor reviewing patient records on the doctor's browser 125, typically involves one or more of the following activities: a) retrieving and associating the electronic image signature of the signer, such as the doctor, with the document being signed; b) computing a watermark ID based on the document information, associated patient information, etc. c) incorporating the watermark ID with the electronic image signature; d) selectively displaying the signed document with the watermarked signature; e) saving the signed document along with the electronic image signature merged with the watermark ID, with the electronic image signature and the watermark ID (both not merged), or with only the electronic image signature; f) modifying the status of the document as changed in the database where such documents are saved, such as the patient records database in the patient server 117; and g) using digital certificates, public and private keys of the signer, such as a doctor, creating a digital signature of the signed document (with or without the electronic image signature and the watermark ID) and saving it with the signed document.

Using the exemplary signing process described above, the watermarked signature of a doctor incorporating both the doctor's electronic image signature retrieved from a signature repository and verification system as well as the watermark ID computed by the associated server, such as the patient server 117, is displayed and selectively attached or associated with a document being reviewed and approved by the doctor. The consumers of signed information, such as a home healthcare agency receiving the signed document from the doctor, selectively verify the doctor's signature associated with the signed information. Based upon the capability of the software or system that acts as a consumer of signed information or as a displayer of signed information, such as the payer/monitor browser 133, either one or both of the forms of signatures—namely, the watermarked electronic image signatures and digital signatures, are used for verification of the authenticity of the creator of the signed information.

In the healthcare network 105, the signature repository and verification system 149 provides support for: registration of digital signatures and electronic image signatures of various information producers and consumers, who typically are subscribers; creating a unique private-key and public-key pair for each subscriber; securely dispensing private keys to such subscribers; access of public keys of registered subscribers based on one or more criteria; access to certificates by subscribers for inclusion with digitally signed information; access of electronic image signatures of subscribers; verification of digital signatures and electronic image signatures; selectively computing watermark IDs for signatures based on one or more inputs; verification of authenticity of certificates; and verification of the authenticity of watermarked electronic image signatures.

The healthcare network 105 also comprises the patient server 117 that provides access to patient records stored in a patient records database while also accessing the signature repository and verification system 149, as necessary, to retrieve the public-keys of various consumers of information for encryption of such information, and to retrieve electronic image signatures of producers of documents so that the electronic image signatures may be incorporated into, or associated with, the documents produced. In addition, the patient server 117 is used to retrieve patient records based on a given watermark ID. Such watermark ID may have been retrieved from a printed patient document or provided as input to a search screen, such as a document search screen provided to a patient using the patient browser 123.

FIG. 2 is a perspective block diagram of an exemplary patient's document 201 into which is embedded an electronic image signature 205 of the doctor along with a unique watermark ID, when the doctor signs the document. Typically, the patient's document 201 comprises a patient profile section 213, a diagnosis section 211, a medication section 207, the electronic image signature section 205, and the watermark ID section 217. In one embodiment, the electronic image signature section 205 is used to store the electronic image signature of the individual who signed the document, such as a doctor, and the watermark section 217 is used to store the unique watermark ID associated with the signed document, both the electronic signature and the watermark ID assigned to the document after the document is signed. In another embodiment, a watermarked electronic image signature is stored in the electronic image signature section 205, and, in addition, the watermark ID is stored in the watermark section 217. In yet another embodiment, the watermarked electronic image signature is stored in the electronic image signature section 205, and the watermark ID is not stored with the document—instead, it is computed as and when required using a formula that takes one or more relevant parameters, such as a patient and document information.

In a different embodiment, the electronic image signature section 205 is used to store one or more electronic image signatures of the individuals who signed the document, such as those of one or more doctors or nurses. In this embodiment, only one watermark ID is employed for all the electronic image signatures, and is stored in the watermark section 217. In a related embodiment, more than one watermark ID is employed, and they are all stored in the watermark section 217.

In one embodiment of the patient document 201, the electronic image signature 205 is not embedded into the patient document 201 and is stored external to the patient document 201. Only a reference to the electronic image signature 205 is stored in the patient document 201, which is then encrypted or decrypted as part of the patient document 201 whenever the patient document 201 in encrypted or decrypted. If a user of the patient document 201 needs to verify the signature of the person (such as a doctor) that signed the document, then the reference to the electronic image signature 205 is retrieved from the patient document 201 and the reference is used to retrieve the actual electronic image signature 205 for viewing purposes. The reference to the electronic image signature 205 may alternatively be stored in the watermark ID field 217.

In one embodiment, the patient's document 201, including the electronic image signature 205, is digitally signed by the doctor (for example, when a doctor activates a sign button on a browser frame) while viewing via the doctor's browser application 125, by using a digital certificate and an associated private-key issued to the doctor by the healthcare network 105. The signed document is then stored in the patient's records database 119, either in the encrypted format; after decryption by the patient server using the public key of the doctor; or after decryption by the patient server using the public key of the doctor and the subsequent encryption using the private key of the patient server. When a user, such as a patient using a patient's browser 123, views the signed document, the patient server retrieves the patient's document 201, encrypts it using a patient's public-key and sends it to the patient's browser 123, where the patient's document 201 is decrypted by the patient browser 123 using a patient's private key and then displayed on the patient browser 123.

In one embodiment of the patient document 201, the electronic image signature 205 is not embedded into the patient document 201 and is stored external to the patient document 201. Only a reference to the electronic image signature 205 is stored in the patient document 201, which is then encrypted or decrypted as part of the patient document 201 whenever the patient document 201 in encrypted or decrypted. If a user of the patient document 201 needs to verify the signature of the person (such as a doctor) that signed the document, then the reference to the electronic image signature 205 is retrieved from the patient document 201 and the reference is used to retrieve the actual electronic image signature 205 for viewing purposes.

Typically, the patient document 201 is generated as an eXentisible markup language (XML) file, either by a home healthcare/nursing home server 121 or by a patient server 117, in response to a doctor's activities using the doctor's browser 125. In addition, the patient server generates such XML files based on the patient's records available in the patient records database 119, the correlation of drug interaction information associated with the patient's record and the drug interaction information available at the drug interaction server 129, the patient's information available at the lab/testing servers 137, etc. Specifically, if during the generation of the XML file, the patient server 117 discovers that a clinical study or research is being conducted in which the patient could participate, this fact is brought to the doctor's attention by creating a corresponding highlighted box in the XML file.

In one exemplary embodiment, when a doctor using the doctor's browser 125 activates the viewing of a patient's information in the doctor's browser 125, an XML file containing the patient's information is sent to the doctor's browser by the patient server 117. The doctor's browser 125 parses the XML file containing the patient's information, or some component associated with the doctor's browser 125, and the information contained in the XML file is displayed on the doctor's browser 125.

In general, the signed patient document 201 can be securely transmitted between the patient server 117 and a user's browser, such as the doctor's browser 125, using public and private keys, of the patient server and the recipient's of the patient's document 201, previously established and stored in the signature repository and verification system 149. However, when the patient's document is printed or viewed on a screen, if the fact that the signed patient's document 201 has been signed, say by a doctor, has to be indicated (in the printout or on the screen), then the electronic image signature 205 is incorporated into the display of the patient document 201, along with a watermark ID uniquely identifying the patient's document, the watermark ID computed by the patient's server (or alternatively, by the user's browser) and merged with the electronic image signature 205 for display purposes.

FIG. 3 is a block diagram showing the details of a print and a display operation for a patient document that has an associated electronic image signature with watermark ID. At a block 301, the processing starts, and at a block at a block 305, a user of a healthcare network, such as a doctor, patient, nurse, home healthcare agency, hospital, etc. retrieves a document that employs digital signatures for providing secure access to documents and other information as well as an electronic image signatures to authenticate the documents and other information. Then, at a block 307, the retrieved patient document is decrypted.

Later, at a block 311, the position of the electronic image signature on the patient document is determined and, at a block 313, the watermark ID is computed for the document, using a formula that selectively employs several inputs, one of them being the document information and another being the information about a signer of the document, such as the information about a doctor signing a patient records.

Subsequently, after the document has been signed by the signer (using appropriate GUI or browser screen), at a block 315, the electronic image signature of the signer, and the watermark ID computed, are merged into a single image in order to print or view the document on the screen along with the watermarked signature. In addition, the watermarked electronic image signature is positioned in specific user specified coordinates (or default coordinates) on the patient document, before executing the branch at the next block 317 where it is determined if the user intends to print or view the document. Based on user preference, one of either block 319 or 321 is executed, to either print the patient document with inclusion of the watermarked electronic image signature on a printer or to display the patient document with inclusion of the watermarked electronic signature on a GUI screen, such as a browser screen, respectively, before terminating execution at a block 323. Such visual display or the insertion of the watermarked electronic image signature in the printed output helps confirm to the user the fact that the document has been previously signed, while also providing information about the signer's identity and the ability to verify that the document and the signature belong together using the watermark ID to retrieve the document electronically.

Although the signing of documents in the medical field has been described in this application, the same approach can be applied to the process of signing documents in other fields too, such as in the legal field where an attorney signs documents, or in the field of banking where a customer signs receipts and bills, etc.

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and appended diagrams.

1. A healthcare network comprising:
a document database that stores at least one patient document having a digital signature of a signor;
a web server communicatively coupled to the document database;
a computer, communicatively coupled to the web server, running browser software used to review the at least one patient document;
at least one web page, selectively delivered by the web server to the computer, that displays the at least one patient document and at least an indication of the digital signature; and
the computer responding to input via the at least one web page by at least causing generation of a watermark ID based on at least information regarding the signor.

2. The healthcare network of claim 1 wherein the generation is further based on at least one of information regarding the patient document and information regarding the patient.

3. The healthcare network of claim 1 wherein the digital signature comprises an electronic image signature.

4. The healthcare network of claim 1 wherein the healthcare network selectively verifying the authenticity of the at least one patient document using the watermark ID.

5. The healthcare network of claim 1 wherein the healthcare network selectively verifying the authenticity of the at least one patient document using the watermark ID and the digital signature.

6. The healthcare network of claim 1 wherein the computer responding to input via the at least one web page by causing merger of the watermark ID with the digital signature.

7. The healthcare network of claim 1 wherein the computer displays the watermark ID with or without the digital signature.

8. The healthcare network of claim 1 wherein the watermark ID comprises a barcode.

9. The healthcare network of claim 1 wherein the computer responding to input via the at least one web page by at least causing association of the watermark ID with the at least one document.

10. The healthcare network of claim 1 wherein the computer responding to input via the at least one web page by at least causing, using the at least an indication of the digital signature, an electronic image signature to be obtained from a database.

11. A method of verifying the authenticity of a patient document in a healthcare network comprising:
retrieving a patient document from a document database having a digital signature of a signor;
generating a watermark ID based on at least information regarding the signor; and
displaying the watermark ID on a screen for review.

12. The method of claim 11 wherein the generation is further based on at least one of information regarding the patient document and information regarding the patient.

13. The method of claim 11 wherein the digital signature comprises an electronic image signature.

14. The method of claim 11 further comprising merging the watermark ID with the digital signature.

15. The method of claim 11 further comprising displaying the digital signature with the watermark ID.

16. The healthcare network of claim 11 wherein the watermark ID comprises a barcode.

17. The method of claim 11 further comprising associating the watermark ID with the patient document.

18. The method of claim 11 further comprising obtaining an electronic image signature from a database.

19. A patient management system comprising:
a user interface;
a patient document that has a digital signature of a signor; and
a processor that responds to the user interface by generating a watermark ID using at least information regarding the signor.

20. The patient management system of claim 19 wherein the generation is further based on at least one of information regarding the patient document and information regarding the patient.

21. The patient management system of claim 19 wherein the digital signature comprises an electronic image signature.

22. The patient management system of claim 19 wherein the processor merges the watermark ID with the digital signature.

23. The patient management system of claim 19 wherein the processor causing display of the watermark ID with or without the digital signature.

24. The patient management system of claim 19 wherein the watermark ID comprises a barcode.

25. The patient management system of claim 19 wherein the processor associates the watermark ID with the patient document.
